(19) United States
(12) Patent Application Publication
(10) Pub. No.: US 2023/0056503 A1
(43) Pub. Date: Feb. 23, 2023

(54) ELECTRIC HEATING DEVICE FOR EXHAUST LINE

(71) Applicant: FAURECIA SYSTEMES D'ECHAPPEMENT, Nantrerre (FR)

(72) Inventors: Alexandre WESTERMANN, BELFORT (FR); Marion GONZALEZ, MONTBELIARD (FR); Guillaume AUFRANC, COURCELLES-LES-MONTBELIARD (FR); Sylvain DHONDT, Saint-Germain (FR); Jaroslaw JAWORSKI, Augsburg (DE)

(21) Appl. No.: 17/874,461

(22) Filed: Jul. 27, 2022

(30) Foreign Application Priority Data
Aug. 2, 2021 (FR) 21 08398

(51) Int. Cl. H05B 3/26

(52) U.S. Cl. CPC H05B 3/26

(57) ABSTRACT

A heating device for an exhaust line comprises a substantially flat, perforated, metallic heating element, limited by a shape substantially identical to a section through which the exhaust line passes. The heating element is arranged across the section, The heating device also includes at least one substantially flat, perforated, rigid disk, limited by a shape substantially identical to the section and shaped to support the heating element.

### CROSS-REFERENCE TO RELATED APPLICATIONS

This application is a U.S. non-provisional application claiming the benefit of French Application No. 21 08398, filed on Aug. 2, 2021, which is incorporated herein by reference in its entirety.

### TECHNICAL FIELD

The disclosure relates to an electric heating device for an exhaust line.

### BACKGROUND

In order to post-treat exhaust gases, it is known to use a catalyst to convert polluting exhaust gases into gases that are less harmful to humans and the environment. Such a catalyst requires, in order to be fully operational, to reach or exceed a high operational temperature, or ignition temperature, typically of the order of 300 to 400° C. for a three-way catalyst and of the order of 200 to 250° C. for a selective reduction catalyst for nitrogen oxides. This ignition temperature is not reached when the engine is started, even for a catalyst placed as close as possible to the engine.

It is therefore known to use a heating device, usually electrical, located upstream of the catalyst in order to preheat the catalyst before engine start-up or to heat it after engine start-up, directly by conduction or indirectly by convection via the exhaust gases passing through it, so that the catalyst reaches its ignition temperature as quickly as possible.

In a heating device, heating is conventionally obtained by Joule effect, by circulating an electric current through a metallic heating element arranged within the exhaust line.

In order to obtain a rapid rise in temperature, a metallic heating element is used, advantageously presenting the lowest possible thermal inertia. In order to achieve a rapid temperature rise, the resistance of the heating element must be increased. It is also important that the heating element is as ventilated as possible in order to let the exhaust gas circulate and to cause as little back pressure as possible. For these three reasons, the heating element should be as light as possible. To achieve this, it is possible to increase the number and size of the perforations in the heating element. The increase in size is limited when the exhaust gases are no longer heated sufficiently when passing through the heating element. The increase in the number of perforations finds its limit in the width of the electrical tracks. The thickness of the heating element is also reduced to a minimum. This results in a reduction of the weight of the heating element. A disadvantage of this weight reduction is that such a heating element presents low frequency vibratory modes, substantially lower than 150 Hz for a diameter greater than 140 mm. This tends to weaken the heating element. Calculations show the need for a vibratory mode at least equal to 250 Hz for commercial vehicle applications and 200 Hz for light vehicles.

Also, the disclosure proposes solutions in order to stiffen the heating element, while supporting the constraints of an exhaust line, chemical: acid or basic, urea or ammonia, particles, thermal: temperature which can reach 700° C. for commercial vehicles and 1050° C. for light vehicles, mechanical: vibratory frequency greater than 250 Hz, vibrations presenting accelerations which can reach 10 to 15 G, electrical: the stiffening elements external to the heating element must be dielectric or galvanically insulated relative to the heating element.

### SUMMARY

The subject disclosure provides a heating device for an exhaust line, which comprises a substantially flat, perforated heating element limited by a shape substantially identical to a flow section of the exhaust line, and which is arranged across the section. At least one substantially flat, perforated, rigid disk is limited by a shape substantially identical to the flow section and is shaped to support the heating element.

Particular features or embodiments, which may be used alone or in combination, are:
the at least one substantially flat, perforated, rigid disk is attached to the heating element,
said at least one disk comprises a first disk, arranged on one side of the heating element and a second disk, arranged on the other side of the heating element,
one disk presents a reticulated shape, preferably with a square, round, triangular or hexagonal mesh,
one disk presents a radiating shape comprising at least one first rib according to a closed contour substantially parallel to the flow section and at least two second, partial or complete, straight radial ribs,
the heating element presents radial nodes where the heating element is less perforated, and the said at least two second ribs of at least one of the disks are superimposed with the nodes,
the number of said at least two second ribs of both disks is a sub-multiple, preferably half, of the number of nodes and the said at least two second ribs of one disk are offset relative to said at least two second ribs of the other disk,
the heating element further comprises at least one annular zone, substantially homothetic to the flow section, not perforated,
one of said at least one first rib is substantially superimposed with said at least one annular zone,
a disk is fixed with the heating element via at least one fixing spacer, preferably fixed in said at least one annular zone.

In a second aspect of the disclosure, an exhaust line comprises at least one such heating device.

### BRIEF DESCRIPTION OF THE DRAWINGS

The disclosure will be better understood from the following description, made only by way of example, and with reference to the appended figures in which:

FIG. 1 shows, in perspective view, an embodiment of a heating device,

FIG. 2 shows, in exploded view, the heating device of FIG. 1,

FIG. 3 shows an assembly mode of the heating element/disks, in exploded view on the left and in assembled view on the right,

FIG. 4 shows a 24-section heating element,

FIG. 5 shows a detail of FIG. 3,

FIG. 6 shows an 18-section heating element,

FIG. 7 shows a detail of FIG. 5,

FIG. 8 shows a mode of superimposition of the disks,

FIG. 9 shows, in perspective view, a heating device according to another embodiment,

FIG. 10 shows a detail of the embodiment of FIG. 9, and

FIG. 11 shows a fixing spacer.

### DETAILED DESCRIPTION

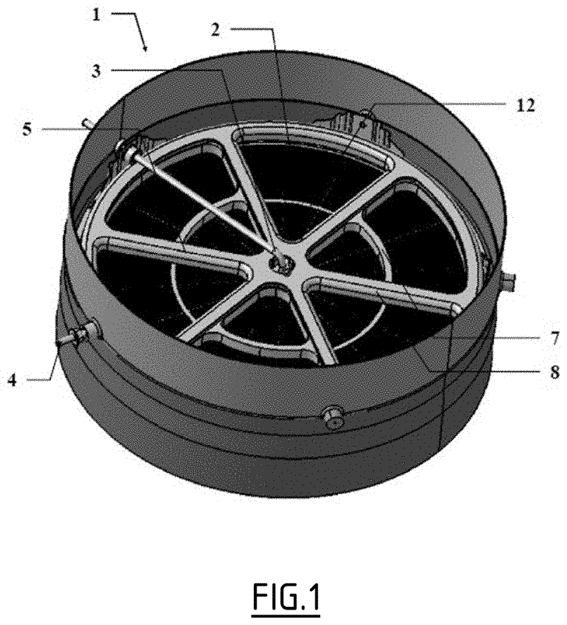

With reference to FIG. 1, the disclosure relates to a heating device 1. Such a heating device 1 is integrated into an exhaust line. This exhaust line is intended to be fitted to a vehicle. This vehicle may be a motor vehicle, such as a car, a van, a truck, a bus, an airplane, a boat, etc. Alternatively, the heating device 1 can be fitted to a stationary source such as the exhaust of a generator.

The function of the heating device 1 is to heat or preheat the exhaust gases during the engine start-up phases, in order to heat an exhaust gas purification device, such as a catalytic converter, to enable it to reach its ignition temperature.

Such a heating device 1 comprises a metallic, substantially flat heating element 2. This heating element 2 is perforated in order to allow the passage of the exhaust gases, while ensuring an intimate contact with the heated heating element 2.

The heating element 2 presents a thickness of between 0.5 and 50 mm, preferably between 0.7 and 5 mm, and more preferably between 0.8 and 3 mm.

The exhaust line incorporating the heating device 1 presents a flow section S which can be any shape. According to preferred embodiments, this flow section can be elliptical, circular, or rectangular with rounded edges. The heating element 2 presents a shape substantially identical to this section S of the exhaust line. The heating element 2 is arranged across the section S, so as to close it and force the exhaust gas to pass through the heating element 2.

When the heating element 2 is circular in shape, it presents a diameter between 50 and 500 mm, preferably between 100 and 400 mm, and more preferably between 220 and 340 mm.

According to one possible embodiment, a heating element 2 is made from a thin metal plate in which perforations are made. These perforations can be made by electrical, chemical, or laser machining, or preferably by stamping. The heating element 2 can also be made of an electrically conductive material such as a metallic foam, a honeycomb, a metallic mesh or any other element allowing such heating.

As seen, this heating element 2, weight reduced to the extreme to meet thermal inertia requirements, becomes mechanically fragile, in particular because of its vibratory characteristics, mainly axial.

Also, according to one feature, the heating device 1 further comprises at least one disk 5, 6. This at least one disk 5, 6 is substantially flat. It is perforated in order to let the exhaust gases pass through. It is rigid in order to provide rigidity to the heating element 2. It presents a shape substantially identical to the section S and is shaped to support the heating element 2.

According to another feature, a disk 5, 6 is attached to the heating element 2, in order to increase the rigidity of the latter.

According to one feature, said at least one disk 5, 6 comprises a single disk. In this case, this disk is preferably a disk arranged to support the heating element 2 against the exhaust gas flow.

According to another preferred feature, said at least one disk 5, 6 comprises two disks 5, 6 arranged on either side of the heating element 2. A first disk 5 is arranged on one side of the heating element 2 and a second disk 6 is arranged on the other side of the heating element 2.

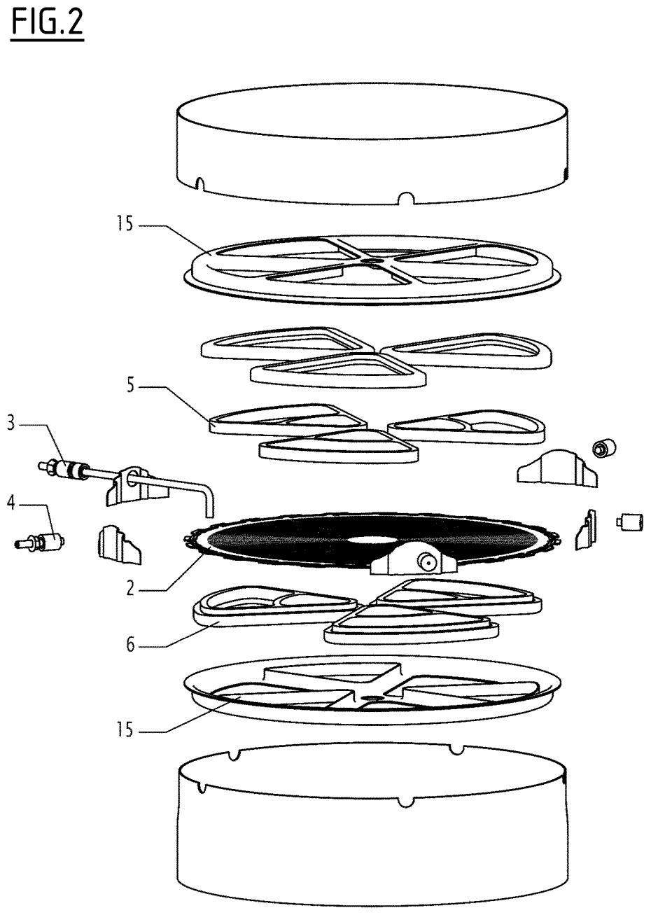

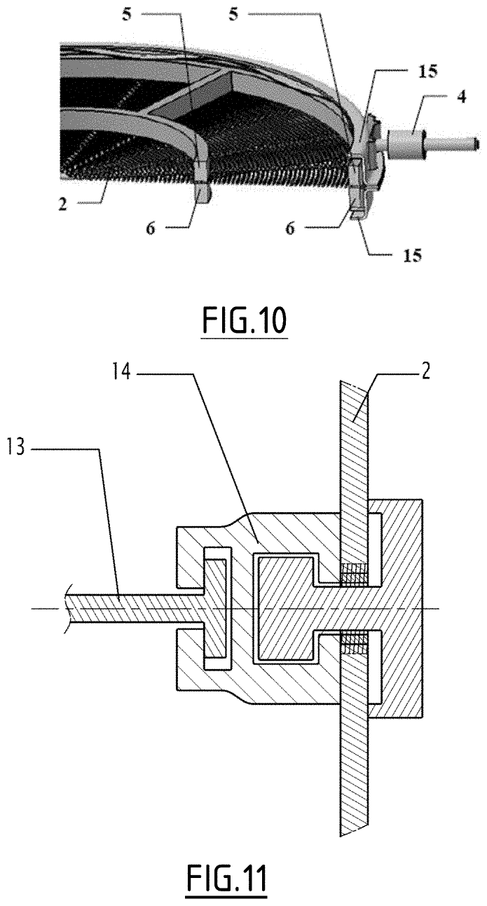

According to one possible embodiment, more particularly illustrated in FIGS. 2, 9, 10, the disk(s) is/are attached to the heating element 2 with a cup 15 that holds it/them together and optionally ensures their contact. A cup 15 holds a disk 5, 6 at least by its periphery. It can also take on all or part of the shape of the disk 5, 6.

According to another feature, a disk 5, 6 is made of ceramic, selected from cordierite, alumina, silica, silica carbide, silica nitride, magnesium oxide or other equivalent, or of a composite material preferably based on mica, these materials being able to withstand a high temperature. Such materials are sufficiently rigid to provide the desired mechanical reinforcement. They are not too heavy so as not to worsen the weight balance. Advantageously, they are chemically inert and resilient. Advantageously, they are dielectric and thus do not risk interfering with the electrical operation of the heating element 2 under power.

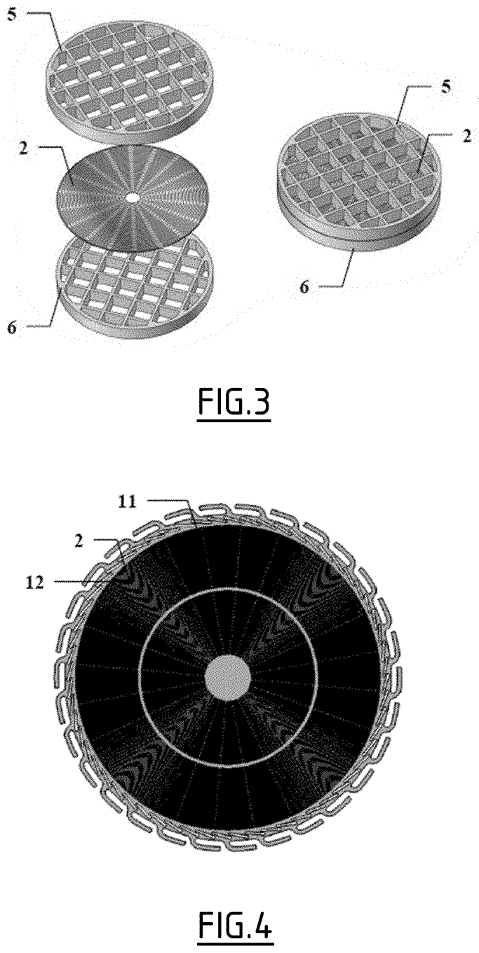

According to another feature, more particularly illustrated in FIG. 3, a disk 5, 6 has a reticulated shape. The mesh size of this network may be any. For ease of manufacture, a regular mesh is preferred, namely a square, round, triangular or hexagonal mesh.

According to another feature, more particularly illustrated in FIG. 2, a disk 5, 6 presents a radiating shape comprising at least one first rib 7 according to a closed contour substantially parallel/homothetic to the section S and at least two radial rectilinear second ribs 8. These radial second ribs 8 may be substantially complete in that they completely traverse a radius or may be only partial. According to another feature, a disk 5, 6 may be, as shown in FIG. 9, in one piece or as shown in FIG. 2, composed of several parts.

In order to be heated, a heating element 2 requires the passage of an electric current. This is achieved by using at least one, advantageously two electrodes 3, 4 in contact with the heating element 2 so as to pass a current through the heating element 2. According to a first feature, the two electrodes may be peripheral. According to another feature, more particularly illustrated in FIG. 2, one electrode 3 is central and the other electrode 4 is peripheral.

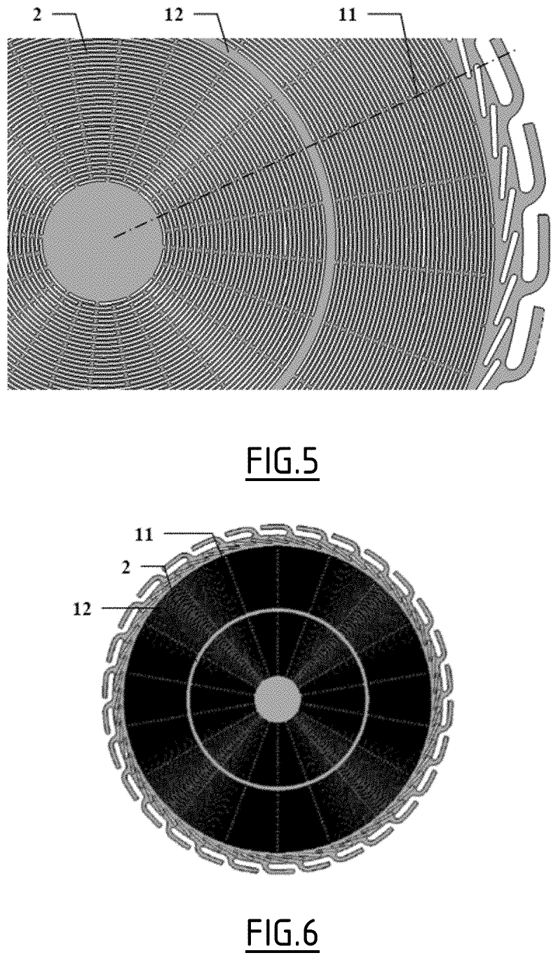

According to another feature, a heating element 2 may present nodes 11. These nodes 11 are zones where the heating element 2 comprises fewer perforations and is less open. The shape of these nodes 11 may be any shape. Advantageously, they are substantially linear in shape. As shown in FIGS. 3-6, the heating element 2 presents radial nodes 11.

These nodes 11, including fewer perforations, present a lower electrical resistance than the surrounding zones and will therefore heat up less when the heating element 2 is subjected to an electrical current. This thermal property is used to superimpose ribs 7, 8 with these nodes 11. This is advantageous in that superimposing a rib 7, 8 with the heating element 2 can create overheating in the superimposed zone, which is less ventilated by the exhaust gases. It is therefore advantageous to have a node 11 in this zone to reduce heating. Radial nodes 11 can advantageously be superimposed with some of the second radial ribs 8 of at least one of the radially shaped disks 5, 6, as shown in FIG. 2, 8, 9 or 10.

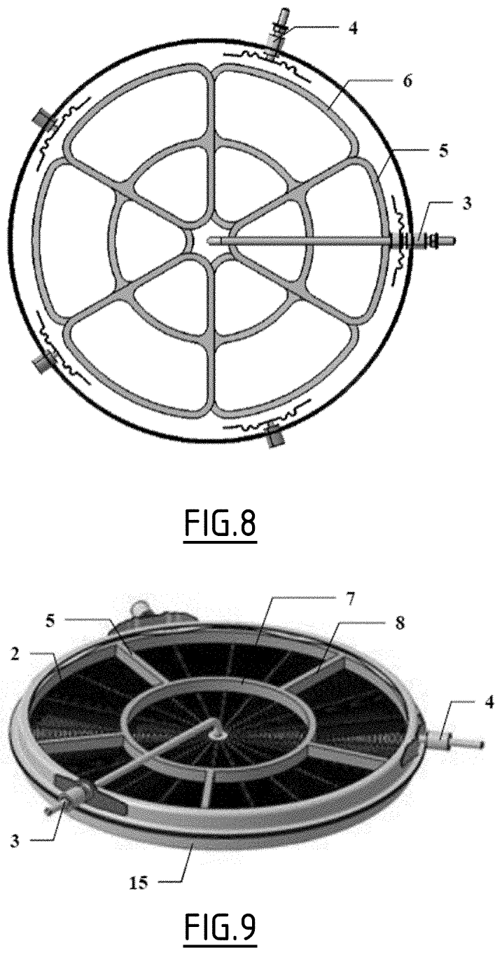

Also, in this case, according to another feature, the number of said at least two second ribs 8 of the two disks 5, 6 is a sub-multiple, preferably half, of the number of nodes 11. Furthermore, said at least two second ribs 8 of one disk 5 are offset relative to said at least two second ribs 8 of the other disk 6. Thus, as illustrated in FIG. 2 or 4, a heating element 2 includes twenty-four radial nodes 11 and each disk 5, 6 comprises six radial second ribs 8. The first disk 5 is advantageously angularly offset relative to the second disk 6 to reduce hot spots. FIG. 1 shows an example where the disks 5, 6 superimpose. FIG. 8 shows an example where the disks 5, 6 are staggered.

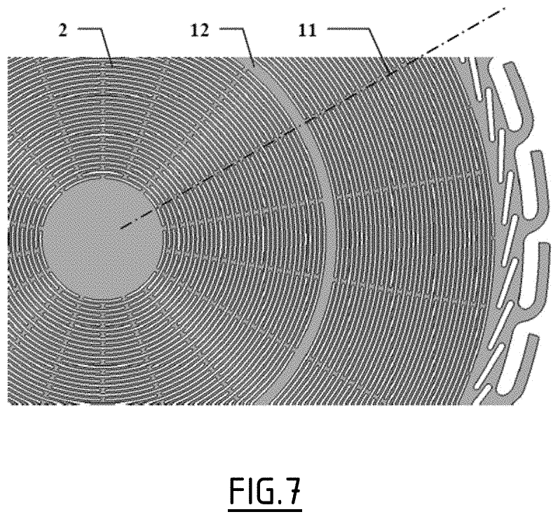

Another way to stiffen the heating element 2 is to act directly on the heating element 2. For this purpose, according to another feature, the heating element 2 comprises at least one more zone 12 with more material, in that it includes fewer or no perforations and is little or not open. In order to obtain a good stiffening, in particular at the vibratory level, as illustrated in FIGS. 4-7, this zone 12 is preferably annular, according to a ring shape substantially homothetic to the section S.

According to another feature, the zone 12 is arranged between the first and second thirds, preferably about half, and ideally half, of the radius of the heating element 2.

As previously mentioned, the zone 12 being less perforated is also less hot. Also, it is advantageous to substantially superimpose one of said at least one first rib 7, also annular, with said at least one zone 12.

It has been seen that a disk 5, 6 can be attached to the heating element 2 by any method. According to another feature, a disk 5, 6 can be fixed with the heating element 2. Such a fixing is carried out, for example, via at least one fixing spacer 13 as illustrated in FIG. 11. This fixing spacer 13 is preferably fixed or integral with the disk 5, 6 by one of its ends and preferably fixed with the heating element 2 by its other end, preferably in said at least one zone 12. This zone 12, presenting more material, is better able to take up the fixing forces. This fixing to the heating element 2 can be carried out by any method: welding, screwing, clipping, gluing, or other equivalent.

Advantageously, in the case where the fixing spacer 13 or the disk 5, 6 is metallic, it is advisable to carry out a galvanic insulation. Also, the said at least one fixing spacer 13 comprises an insulating medium 14, between the heating element 2 and the disk 5, 6. This is illustrated in FIG. 11.

The disclosure further relates to an exhaust line comprising at least one such heating device 1.

The disclosure has been illustrated and described in detail in the drawings and the preceding description. The latter should be considered as illustrative and given by way of example and not as limiting the disclosure to this description alone. Many alternative embodiments are possible.

### LIST OF REFERENCE SIGNS

1: heating device,
2: heating element,
3, 4: electrodes,
5, 6: disk,
7: first rib,
8: second rib,
11: node,
12: annular zone,
13: fixing spacer,
14: insulating medium,
15: cup.

1. A heating device for an exhaust line, comprising:
a heating element that is substantially flat, perforated, metallic, and limited by a shape substantially identical to a flow section of the exhaust line, and wherein the heating element is arranged across the flow section; and
at least one disk that is substantially flat, perforated, and rigid, wherein the at least one disk is limited by a shape substantially identical to the flow section and shaped to support the heating element.

2. The heating device according to the claim 1, wherein the at least one disk is attached to the heating element.

3. The heating device according to the claim 1, wherein the at least one disk comprises a first disk, arranged on one side of the heating element and a second disk, arranged on an opposite side of the heating element.

4. The heating device according to the claim 1, wherein the at least one disk presents a reticulated shape.

5. The heating device according to the claim 1, wherein the at least one disk presents a radiating shape comprising at least one first rib according to a closed contour substantially parallel to the flow section and at least two partial or complete radial straight second ribs.

6. The heating device according to the claim 5, wherein the at least one disk comprises at least a first disk and a second disk, and wherein the heating element presents radial nodes where the heating element is less open, wherein the at least two partial or complete radial straight second ribs of at least one disk of the first and second disks are superimposed with the radial nodes.

7. The heating device according to the claim 6, wherein a number of the at least two partial or complete radial straight second ribs of the first and second disks is a sub-multiple of a number of radial nodes, and the at least two partial or complete radial straight second ribs of the first disk are offset relative to the at least two partial or complete radial straight second ribs of the second disk.

8. The heating device according to claim 5, wherein the heating element further comprises at least one annular zone, substantially homothetic in shape to the flow section, which is not perforated.

9. The heating device according to claim 8, wherein one of the at least one first rib is substantially superimposed with the at least one annular zone.

10. The heating device according to the claim 8, wherein the at least one disk is fixed to the heating element via at least one fixing spacer.

11. An exhaust line comprising at least one heating device according to claim 1.
